(19) United States
(12) Patent Application Publication
(10) Pub. No.: US 2011/0072503 A1
(43) Pub. Date: Mar. 24, 2011

(54) METHOD OF AUTHENTICATION FOR A WIRELESS ENABLED MEMORY CARD

(76) Inventor: Wayne Joon Yong Tan, Singapore (SG)

(21) Appl. No.: 12/863,547

(22) PCT Filed: Aug. 12, 2009
(86) PCT No.: PCT/SG09/00280

§ 371 Date: Nov. 5, 2010

(30) Foreign Application Priority Data
Sep. 4, 2008 (SG) 2008-000327

(51) Int. Cl. H04L 9/32

(52) U.S. Cl. 726/9

(57) ABSTRACT

A method of authentication for a memory card is disclosed. The method comprises using a wireless-enabled mobile telecommunication-enabled apparatus to wirelessly and directly detect and connect to the memory card, the memory card being wireless-enabled. A keypad of the wireless-enabled mobile telecommunication-enabled apparatus is used to enter and wirelessly send directly to the memory card at least one of a user name and an authentication code. A processor in the memory card compares the user name and/or authentication code with a stored user name and/or authentication code in the memory card. Upon the processor validating the user name and/or authentication code, the memory card is activated for use.

### REFERENCE TO RELATED APPLICATION

Reference is made to our co-pending international patent application PCT/SG2008/000237entitled “Method and Apparatus for Wireless Digital Contact Management” the priority of which is hereby claimed and the contents of which are hereby incorporated by reference (“our earlier application”).

### TECHNICAL FIELD

This invention relates to a method of authentication for memory card and refers particularly, through not exclusively to such a method using a wireless telecommunication-enabled device with a keypad.

### BACKGROUND

In our earlier application there is disclosed a memory card having wireless capability for use in digital cameras. For security purposes it is of assistance to have such a memory card with wireless capability being able to be secured. This may be by use of a user name and/or authentication code, or other similar code system. However, a digital camera needs a keypad to be able to insert such a code.

It is therefore desirable to have a method of being able to insert such a code for authentication or like purposes.

### SUMMARY

According to an exemplary aspect there is provided a method of authentication for a memory card. The method comprises using a wireless-enabled mobile telecommunication-enabled apparatus to wirelessly and directly detect and connect to the memory card, the memory card being wireless-enabled. A keypad of the wireless-enabled mobile telecommunication-enabled apparatus is used to enter and wirelessly send directly to the memory card at least one of a user name and an authentication code. A processor in the memory card compares the user name and/or authentication code with a stored user name and/or authentication code in the memory card. Upon the processor validating the user name and/or authentication code, the memory card is activated for use.

If the user name and/or authentication code are not correct the memory card may wirelessly send an error message directly to the wireless-enabled mobile telecommunication-enabled apparatus for display on a screen of the wireless-enabled mobile telecommunication-enabled apparatus. Upon receipt of the error message the keypad may be used to re-enter and wirelessly re-send the user name and/or authentication code directly to the memory card. The processor in the memory card may compare the user name and/or authentication code with the stored user name and/or authentication code in the memory card. If the re-sent user name and/or authentication code is again not correct the memory card may be frozen and further actions may not proceed.

The user name may be validated before the authentication code can be entered and wirelessly sent for verification.

The memory card may comprise a non-volatile memory module. The user name and/or authentication code may be required for access to at least one of: the memory module of the memory card, and a wireless module of the memory card. The non-volatile memory module may be partitioned into a plurality of storage areas. The plurality of storage areas may be a public storage area and a private storage area. The private storage area may require the user name and/or authentication code for access. The public area may operate without the user name and/or authentication code.

### BRIEF DESCRIPTION OF THE DRAWINGS

In order that the invention may be fully understood and readily put into practical effect there will now be described exemplary embodiments incorporating the principle features of the present invention. The description will be by way of exemplification only and will be with reference to the accompanying illustrative drawings.

In the drawings:

FIG. 1 is a schematic system view showing the apparatus to, be used for the entry of the authentication code; and

FIG. 2 is a flow chart showing the method to be used in the insertion of the authentication code.

### DESCRIPTION OF EXEMPLARY EMBODIMENTS

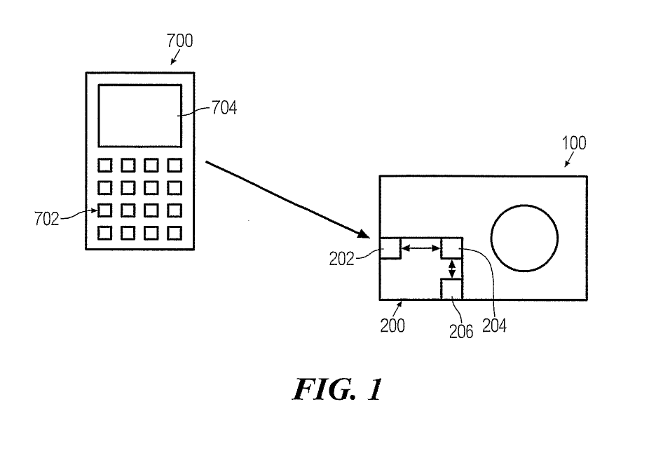

To first refer to FIG. 1 there is shown a digital camera 100 that has in removably inserted it a memory card 200. The memory card 200 is as described in our earlier application, as is the digital camera 100. The method of operation of the memory card 200 and the digital camera 100 are as described in our earlier application. The memory card 200 has a wireless module 202, a processor 204, and a non-volatile memory module 206; the processor 204 being operatively connected to both the memory module 206 and the wireless module 202.

Also shown is a mobile telecommunication-enabled apparatus 700 such as a mobile telephone and that has a keypad 702 and a display 704. The mobile telecommunication-enabled apparatus 700 is wireless enabled with an appropriate wireless standard such as, for example, Wi-Fi, Bluetooth or the like. Similarly, the memory card 200 is wireless enabled with a similar standard such as, for example, Wi-Fi, Bluetooth or the like.

A user name and/or authentication code will have been stored in a non-volatile memory within the card 200 to enable the operation of the card 200. This may be done by removing the card 200 from the digital camera 100 and inserting the card 200 in the relevant port or slot of a computer so that the user name and/or authentication code can be entered using the computer keyboard or other peripheral device (e.g. a microphone and voice recognition). This may also be subsequently used for verification of the user name and/or authentication code. The user name and/or authentication code may be required for access to the memory of the card 200 and/or for the wireless connectivity system of the card 200.

Furthermore, the card 200 may be able to be partitioned into a number of storage areas including, but not limited to, a public storage area and a private storage area. The private storage area would require user name and/or authentication code for access. The public area could operate normally without the user name and/or authentication code.

The mobile telecommunication-enabled apparatus 700 is able to wirelessly directly detect and directly connect to the card 200. As such the keypad 702 is able to be used to enter user names, authentication codes, activation codes, and the like, for the memory card 200 that can be sent by the telecommunication-enabled apparatus 700 both wirelessly and directly to the memory card 200. By directly it is meant that no network is required for the communication between the telecommunication-enabled apparatus 700 and the memory card 200.

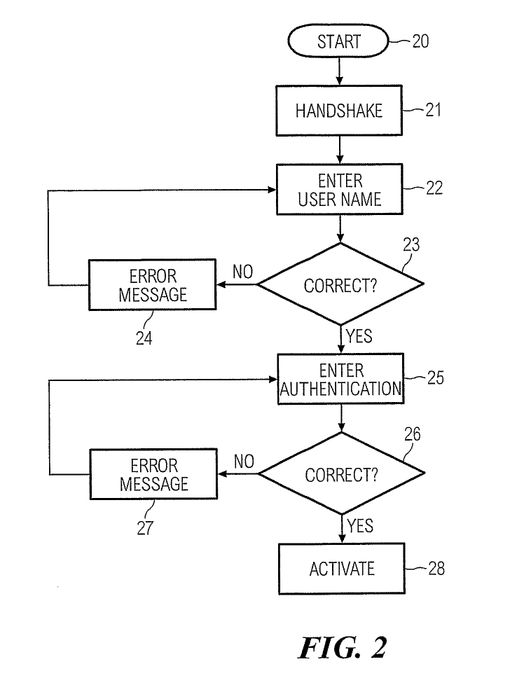

The methodology is shown in FIG. 2. At the start (20) there is a handshake procedure (21). At the handshake procedure (21) the mobile telecommunication-enabled apparatus 700 will wirelessly and directly detect and connect to the card 200. After the completion of the handshake procedure (21) the keypad 702 is used to enter a user name (22). The user name is sent wirelessly by the mobile telecommunication-enabled apparatus 700 directly to the wireless-enabled memory card 200. Upon the user name being received by the memory card 200, the processor 204 makes a determination on the correctness of the user name (23) by reference to a stored user name in the memory card 200. If the user name is not correct, an error message is wirelessly sent (24) directly to the mobile telecommunication-enabled apparatus 700. The mobile telecommunication-enabled apparatus 700 will receive that error message and display it on the screen 704. The keypad 702 can then be used to re-enter and wirelessly re-send the user name (22) directly to the memory card 200 where the process at (23) is repeated. This process may repeat a number of times until the card 200 will be “frozen”. Further actions cannot proceed until the card 200 is removed from the camera 100 and inserted into a computer (not shown) and unfrozen using known techniques.

If the user name is correct at (23) the keypad 702 is used to enter and the telecommunication-enabled apparatus 700 wirelessly sends an authentication code (25) directly to the card 200. Again, a query raised (26) and the processor 204 makes a determination on the correctness of the authentication code by reference to a stored authentication code in the memory card 200 to determine if the authentication code is correct. If it is not correct, a further error message may be wirelessly sent (27) directly to and received by the telecommunication-enabled apparatus 700 for display on the screen 704. The authentication code can then be re-entered (25) and wirelessly resent directly to the memory card 200. Again, after prescribed number of unsuccessful repeats of this process the card 200 will be frozen and no more authentication codes will be considered until it is “unfrozen” as described above.

If the authentication code is correct (26) the card 200 is then activated (28) and can operate as is described in our earlier application.

In one exemplary aspect, the user name must be validated before the authentication code can be entered and wirelessly sent to the memory card 200 for verification.

Whilst the foregoing description has described exemplary embodiments, it will be understood by those skilled in the technology concerned that many variations in details of design, construction and/or operation may be made without departing from the present invention.

1.-10. (canceled)

11. A method of authentication for a memory card, the method comprising:
using a wireless-enabled mobile telecommunication-enabled apparatus to wirelessly and directly detect and connect to the memory card, the memory card being wireless-enabled;
using a keypad of the wireless-enabled mobile telecommunication-enabled apparatus to enter and wirelessly send directly to the memory card at least one of a user name and an authentication code;
a processor in the memory card comparing the user name and/or authentication code with a stored user name and/or authentication code in the memory card; and
upon the processor validating the user name and/or authentication code, the memory card being activated for use.

12. A method as claimed in claim 11, wherein if the user name and/or authentication code are not correct the memory card wirelessly sends an error message directly to the wireless-enabled mobile telecommunication-enabled apparatus for display on a screen of the wireless-enabled mobile telecommunication-enabled apparatus.

13. A method as claimed in claim 12, wherein upon receipt of the error message the keypad is used to re-enter and wirelessly re-send the user name and/or authentication code directly to the memory card and the processor in the memory card compares the user name and/or authentication code with the stored user name and/or authentication code in the memory card.

14. A method as claimed in claim 13, wherein if the re-sent user name and/or authentication code is again not correct the memory card is frozen and further actions cannot proceed.

15. A method as claimed in claim 11, wherein the user name must be validated before the authentication code can be entered and wirelessly sent for verification.

16. A method as claimed in claim 11, wherein the memory card comprises a non-volatile memory module.

17. A method as claimed in claim 16, wherein the user name and/or authentication code are required for access to at least one of: the memory module of the memory card, and a wireless module of the memory card.

18. A method as claimed in claim 16, wherein the non-volatile memory module is partitioned into a plurality of storage areas.

19. A method as claimed in claim 18, wherein the plurality of storage areas comprises a public storage area and a private storage area; the private storage area requiring the user name and/or authentication code for access.

20. A method as claimed in claim 19, wherein the public area operates without the user name and/or authentication code.
